(19) United States
(12) Patent Application Publication
(10) Pub. No.: US 2005/0077074 A1
(43) Pub. Date: Apr. 14, 2005

(54) Shielded flat cable

(75) Inventor: Atsuo Tanaka, Aichi (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Nagoya-shi (JP); SUMITOMO WIRINGS SYSTEMS, LTD., Yokkaichi-shi (JP); SUMITOMO ELECTRIC INDUSTRIES, LTD., Osaka-shi (JP)

(21) Appl. No.: 10/628,378

(22) Filed: Jul. 29, 2003

(30) Foreign Application Priority Data
Jul. 30, 2002 (JP) P2002-221065

(51) Int. Cl. H01B 11/02

(52) U.S. Cl. 174/117 F

(57) ABSTRACT

A shielded flat cable includes a plurality of juxtaposed insulating layer-coated signal wires, a drain wire disposed on one side of the group of the signal wires, a shielding layer covering an outer periphery of the group of signal wires and drain wire, and an insulating sheath covering an outer periphery of the shielding layer. A conductor of at least the outermost signal wire of the plurality of signal wires which is remote from the drain wire is made of a copper alloy.

### BACKGROUND OF THE INVENTION

1. Field of the Invention

The present invention relates to a shielded flat cable, and more particularly to a shielded flat cable suitably used for electrical connection between electrical equipments mounted on a vehicle such as an automobile.

2. Description of the Related Art

Recently, a vehicle mounted electronic equipment such as a vehicle navigation system and a DVD player has become widely used, and it is desired to provide in a vehicle a video finer in resolution and an audio higher in quality. In order to acquire high quality of video and audio signals, a shielded cable is used for connecting the vehicle mounted electronic equipment and other devices such as a rear seat monitor. Considering the numbers of cables arranged within a vehicle and the limit of space available for wiring, a flat-type shielded cable (shielded flat cable), which requires less amount of wiring space than a regular shielded cable, has become in use for wiring in a vehicle. An example of a conventional shielded flat cable is shown in FIG. 7.

The conventional shielded flat cable 100 has a flat structure as a whole, and includes a plurality of insulating layer-coated signal wires 102 and a drain wire 103 which are arranged parallel to one another, a shielding layer 104 covering an outer periphery of the signal wires 102 and the drain wire 103, and an insulating sheath 105 covering an outer periphery of the shielding layer 104. A conductor of each signal wire 102 is usually made of pure copper (softened copper), and is in a form of a stranded wire or a single wire. The drain wire 3 is usually made of pure copper, aluminum or Sn-plated copper, and is in a form of a stranded wire or a single wire. In FIG. 7, reference numeral 102a denotes a conductor of the signal wire 102, and reference numeral 102b denotes an insulating coating layer of the signal wire 102.

In the above configuration, external noises are shielded by the shielding layer 104, and the shielded noises are grounded to an external earth through the drain wire 3, whereby signals high in quality-are supplied to various electrical equipments via the signal wires 102.

In the shielded flat cable described above, which used for connecting the vehicle mounted device and the other devices, it has been desired to achieve a thinner and more lightweight design. Also in the shielded flat cable 100, there need to improve its transmission characteristics (characteristic impedance) in order to match the impedance both of a signal-supplying side and the equipment to prevent an occurrence of a signal reflection, thereby improving the quality of the video and audio signal. From above described points of view, in the shielded flat cable, it is necessary to reduce cross-sectional area (hereinafter referred to as “conductor size”) of the conductor 102a of each signal wire 102 as much as possible (for example, to 0.08 mm² or to 0.13 mm²). On the other hand, when the shielded flat cable 101 is installed, the cable is, in some cases, bent in a direction of the width thereof. In particular, when wiring a cable from a front console of a vehicle to a video monitor provided at rear seats, the cable is normally wired along the inner roof surface of the vehicle. In such a case, the shielded flat cable sags down by its own weight when in wiring. When the shielded flat cable 101 is bent in such a manner, the conductor 102a of the outer signal wire 102 is extended by the bending, and when the shielded flat cable 101 is restored into its original condition, the conductor 102a is in a fully-extended condition because of plastic deformation thereof. As a result, a buckling occurs to the conductor 102a, and in the worst case, the conductor 102a becomes broken and disconnected.

In order to overcome such problems, there may be a solution in which providing a drain wire or a dummy wire at both sides of the signal wires of the shielded flat cable, to thereby improve a flexural strength. However, in such a case, the number of wires increases and the shielded flat cable becomes wide in breadth, whereby the amount of wiring space needed for wiring the shielded flat cable becomes increased.

In a conventional signal cable, there is proposed to use an alloy for a conductor of the signal wire in order to improve flexural fatigue characteristics. However, such a conventional signal cable is used for a wiring under heavily vibrating circumstances, such as wiring for a under vehicle location near suspensions. Therefore, the diameter of the signal wire of such conventional signal cable is made large and there is no concern about improving the impedance or making thin and lightweight design in such conventional signal cable.

### SUMMARY OF THE INVENTION

It is therefore an object of the invention to provide a shielded flat cable in which even when a thin and lightweight design of the shielded flat cable is achieved by reducing a conductor size of conductors of signal wires as much as possible, an occurrence of a buckling and breaking in the conductors of the signal wires is prevented, and transmission characteristics thereof can be more enhanced.

In order to achieve the above object, according to a first aspect the invention, there is provided a shielded flat cable including: a plurality of signal wires each having a conductor coated with insulating layer; a drain wire; a shielding layer covering an outer periphery of the group of the signal wires and the drain wire; and an insulating sheath covering an outer periphery of the shielding layer, wherein the signal wires and the drain wire are juxtaposed to one another in closely-contacted relation to one another, and wherein the conductor of at least the outermost signal wire is made of a copper alloy.

According to a second aspect of the invention, there is provided a shielded flat cable including: a plurality of signal wires each having a conductor coated with insulating layer; a drain wire; a shielding layer covering an outer periphery of the group of the signal wires and the drain wire; and an insulating sheath covering an outer periphery of the shielding layer, wherein the signal wires and the drain wire are juxtaposed to one another in closely-contacted relation to one another, wherein the conductor of at least the outermost signal wire comprises: a linear central wire element disposed at a longitudinal axis of the conductor; and a peripheral wire element stranded around the central wire element therealong, wherein the central wire element is made of copper, and wherein the peripheral wire element is made of copper alloy.

### BRIEF DESCRIPTION OF THE DRAWINGS

The objects and advantages of the present invention will become more apparent by describing preferred exemplary embodiments thereof n detail with reference to the accompanying drawings, wherein:

FIG. 1 is a cross-sectional view showing a structure of a shielded flat cable according to a first embodiment of the invention;

FIGS. 2A to 2C are cross-sectional views showing exemplary forms (stranded wires and single wire) of a conductor of a signal wire of the shielded flat cable;

FIG. 3 is a cross-sectional view showing a modified example of the first embodiment;

FIG. 4 is a cross-sectional view showing a structure of a shielded flat cable according to a second embodiment of the invention;

FIGS. 5A and 5B are views showing exemplary forms of a conductor of a signal wire of the shielded flat cable;

FIG. 6 is a cross-sectional view showing a third embodiment of the invention; and

FIG. 7 is a cross-sectional view showing a structure of a conventional shielded flat cable.

### DETAILED DESCRIPTION OF THE PREFERRED EMBODIMENTS

Referring now to the accompanying drawings, a description will be given in detail of preferred embodiments of the invention.

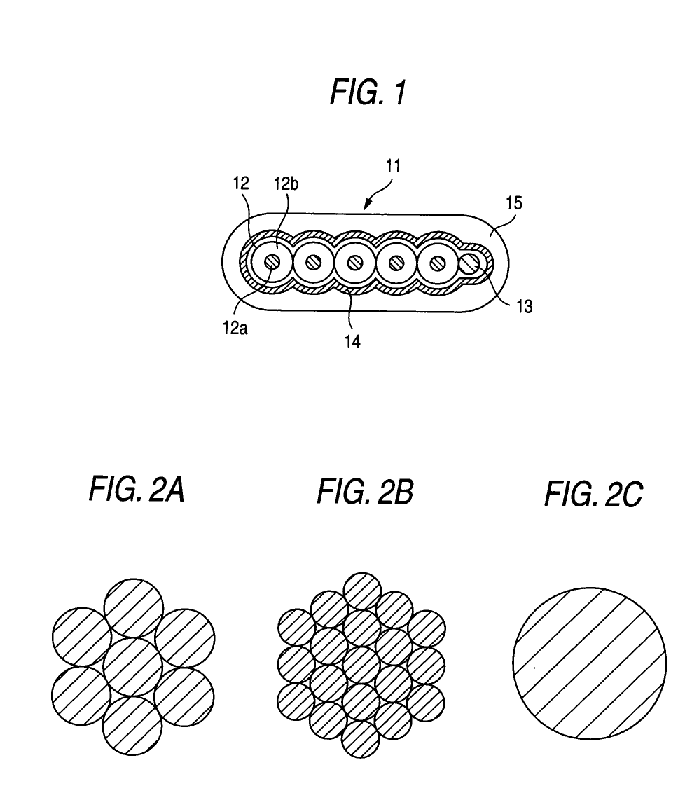

Hereinafter, a shielded flat cable according to a first embodiment of the invention wilt be described. FIG. 1 is a cross-sectional view showing a structure of the shielded flat cable according to the first embodiment.

The shielded flat cable 11 of the first embodiment has a flat structure as a whole, and includes a plurality of (5 in the first embodiment) parallel (or juxtaposed) insulating layer-coated signal wires 12, a drain wire 13 disposed on one side of the group of the signal wires 12 and in parallel with the group of the signal wires 12, a shielding layer 14 covering an outer periphery of a group of the signal wires 12 and the drain wire 13, and an insulating sheath 15 covering an outer periphery of the shielding layer 14. Each of the signal wires 12 includes a conductor 12a, and an insulating coating layer 12b.

The conductor 12a of the signal wires 12 is made of a copper alloy. The copper alloy for the conductor 12a is not limited to any specified kind in so far as it has predetermined electrical conductivity, a tensile strength of about 500 N/mm² to about 1,400 N/mm² and an elongation of about 5% to about 15% (The elongation is set to the value when the diameter φ of an element of the signal wire 12 is 0.1 mm to 0.25 mm; The same shall apply hereinafter). Typically, it is preferred to use a Cu—Ag alloy or a Cu—Ni—Si alloy for the copper alloy for the conductor 12a. Incidentally, commonly used pure copper has a tensile strength of about 250 N/mm² and an elongation of about 10% to about 15%.

In a case of using the Cu—Ag alloy for the conductor 12a, the Ag content is preferably set to 2.5% by weight to 5.5% by weight. The alloy having above composition becomes to have a tensile strength of about 1,200 N/mm² to about 1,350 N/mm² and an elongation of about 1%, and therefore a high breaking strength can be obtained.

In a case of using the Cu—Ni—Si alloy for the conductor 12a, the Ni content is preferably set to 2.0% by weight to 3.0% by weight and the Si content is preferably set to 0.4% by weight to 0.8% by weight. The alloy having above composition becomes to have a tensile strength of about 640 N/mm² and an elongation of about 5% to about 10%, and therefore a high breaking strength can be obtained.

From a viewpoint of a thin and lightweight design, a conductor size (cross-sectional area) of the conductor 12a is preferably about 0.05 mm² to about 0.13 mm². It is further more preferable to design the conductor size of the conductor 12a in a range of from 0.03 mm² to 0.08 mm². When the conductor size of the conductor 12a falls below the lower limit of the above range, the signal wire 12 may not acquire enough strength and may become difficult to prevent the occurrence of breaking. When the conductor size of the conductor 12a exceeds the higher limit of the above range, the signal wire 12 may not acquire enough characteristic impedance. The conductor 12a may be formed with a stranded wire or a single wire. FIG. 2 shows examples of such form. FIG. 2A shows a 7-wire stranded type, FIG. 2B shows a 19-wire stranded type, and FIG. 2C shows a single wire type. The 7-wire stranded type is a standard type, and the 19-wire stranded type is more excellent in flexing resistance, and the single wire-type is advantageous from a viewpoint of a cost.

In the fist embodiment, the conductor 12a of all of the plurality of the signal wires 12 is made of the copper alloy. Alternatively, the conductor 12a of one or more of the signal wires 12 may be made of pure copper while the conductor of the other signal wires 12 may be made of the copper alloy. However, at least the conductor 12a of the outermost signal wire 12 remote from the drain wire 13 is preferable to be made of the copper alloy.

The insulating coating layer 12b of each signal wire 12 may be made of a resin material such as polyvinyl chloride (PVC), polyethylene (including foamed polyethylene), a halogen-free material or a tetrafluoroethylene. A thickness of the insulating coating layer 12b of the signal wire 12 is determined in accordance with the conductor size of the conductor 12a and the outer diameter of the signal wire 12.

The outer diameter of the signal wire 12 is normally set to about 1.25 mm to about 1.40 mm.

The number of the juxtaposed signal wires 12 may be arbitrarily determined according to a use.

The drain wire 13 is made of a metal material, such as pure copper, Sn-plate copper or aluminum, or an alloy material. The drain wire 13 may be a stranded wire or a single wire. A conductor size of the drain wire 13 is normally set to about 0.22 mm² to about 0.3 mm².

The shielding layer 14 is made of a material having a shielding effect, more specifically a copper foil/PET tape, a Sn-plated copper foil/PET tape, an aluminum foil/PET tape or the like, and a thickness of the shielding layer 14 is normally set to about 15 μm to about 21 μm.

The insulating sheath 15 is made of a material having insulating properties, oil resistance and chemical resistance. A resin material, such as polyvinyl chloride, polyethylene, a halogen-free material or polytetrafluoroethylene may be used for the insulating sheath 15. From a viewpoint of a thin and lightweight design, a thickness of the insulating sheath 15 is set to about 0.2 mm to about 0.3 mm, but is not limited to this value.

Hereinafter, a description will be made of a comparison between examples of shielded flat cables of the first embodiment and an example of a conventional shielded flat cable.

A first product (product 1) according to the first embodiment is made with the following characteristics.
shielded flat cable 11;
   width: 3.94 mm, thickness: 1.98 mm
two signal wires 12;
   material for conductor 12a: Cu—Ag, conductor size: 0.08 mm², 7-wire stranded type, material for insulating coating layer 12b: foamed polyethylene, outer diameter of each signal wire: 1.35 mm
drain wire 13;
   material: Sn-plated copper, conductor size: 0.22 mm²
shielding layer 14;
   material: copper foil, thickness: 15 μM
insulating sheath 15;
   material: halogen-free material, thickness: 0.3 mm.

A second product (product 2) according to the first embodiment is made with the following characteristics.
shielded flat cable 11;
   width: 3.94 mm, thickness: 1.98 mm
two signal wires 12;
   material for conductor 12a: Cu—Ni—Si, conductor size: 0.08 mm², 7-wire stranded type, material for insulating coating layer 12b: foamed polyethylene, outer diameter of each signal wire: 1.35 mm
drain wire 13;
   material: Sn-plated copper, conductor size: 0.22 mm²
shielding layer 14;
   material: copper foil, thickness: 15 μm
insulating sheath 15;
   material: halogen-free material, thickness: 0.3 mm.

A conventional product according to a conventional shielded flat cable is made with the following characteristics.
shielded flat cable;
   width: 3.94 mm, thickness: 1.98 mm
two signal wires;
   material for conductor: pure copper, conductor size: 0.08 mm², 7-wire strand type, material for insulating coating layer: foamed polyethylene, outer diameter of each signal wire: 1.35 mm
drain wire:
   material: Sn-plated copper, conductor size: 0.22 mm²
shielding layer;
   material: copper foil, thickness: 15 μm
insulating sheath;
   material: halogen-free material, thickness: 0.3 mm.

The breaking strength of each of the above shielded flat cables was measured. Measurement results are shown in the following.
Product 1 according to the first embodiment: 151 N
Product 2 according to the first embodiment: 74 N.
Conventional Product: 53 N.

As apparent from the above result that in the shielded flat cable of the first embodiment of the invention, even when the conductor size of the conductors of the signal wires are reduced, the buckling and disconnecting of the conductors can be effectively prevented and that the thin and lightweight design of the shielded flat cable can be achieved. It has also been confirmed that even when the cable is forcibly bent in the direction of the width thereof during the installation of the cable, the strength, withstanding the cutting of the conductor, is enhanced.

Although the first embodiment of the invention has been described above, the present invention is not limited to the above configuration, and various modifications and changes can be made.

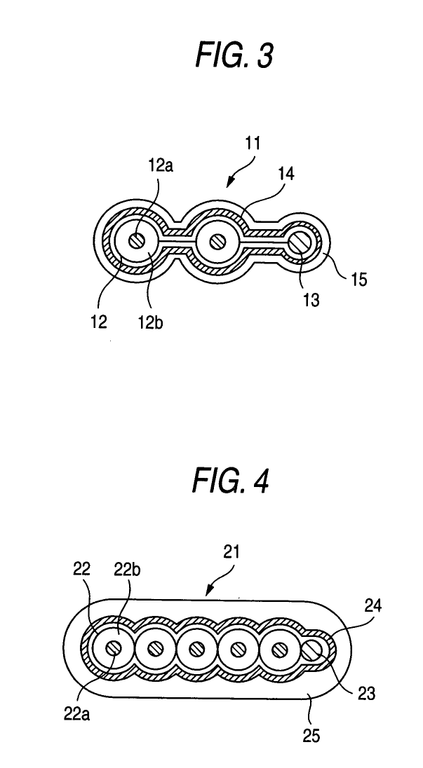

For example, the first embodiment can be applied to a shielded flat cable having a structure shown in FIG. 3. In FIG. 3, similar elements to those of FIG. 1 are designated by identical reference numerals, respectively.

Hereinafter, a shielded flat cable according to a second embodiment of the invention will be described with reference to FIG. 4. FIG. 4 is a cross-sectional view showing a structure of the shielded flat cable of the second embodiment.

As described above for the first embodiment, the shielded flat cable 21 of the second embodiment has a flat structure as a whole, and includes a plurality of (5 in the second embodiment) parallel (or juxtaposed) insulating layer-coated signal wires 22, a drain wire 23 disposed on one side of the group of signal wires 22 and in parallel with the group of the signal wires 22, a shielding layer 24 covering an outer periphery of the signal wires 22 and the drain wire 23, and an insulating sheath 25 covering an outer periphery of the shielding layer 24. Each of the signal wires 22 includes a conductor 22a, and an insulating coating layer 22b.

The conductor 22a of the signal wire 22 of the shielded flat cable 21 has a twisted-wire structure and that the conductor of the twisted-wire structure includes a linear (straight) central wire element 22a′ which is made of copper, and is disposed at a longitudinal axis of the conductor, and a plurality of peripheral wire elements 22a″ which are made of a copper alloy, and are twisted around the central wire element 22a′ therealong. The copper alloy, used as the material for the peripheral wire elements 22a″, is not limited to any specified kind in so far as it has predetermined electrical conductivity, a tensile strength of about 500N/mm² to about 1.400 N/mm² and an elongation of about 5% to about 15%. Typically, it is preferred to use a Cu—Ag alloy and a Cu—Ni—Si alloy for the copper alloy of the peripheral wire element 22a″. Incidentally, pure copper has a tensile strength of about 250 N/mm² and an elongation of about 10% to about 15%.

In a case of using the Cu—Ag alloy for the peripheral wire element 22a″, the Ag content is preferably set to be 2.5% by weight to 5.5% by weight. The alloy having above composition becomes to have a tensile strength of about 1,200 N/mm² to about 1,350 N/mm² and an elongation of about 1%.

In a case of using the Cu—Ni—Si alloy for the peripheral wire element 22a″, the Ni content is preferably set to 2.0% by weight to 3.0% by weight and the Si content is preferably set to 0.4% by weight to 0.8% by weight. The alloy having above composition becomes to have a tensile strength of about 640 N/mm² and an elongation of about 5% to about 10%.

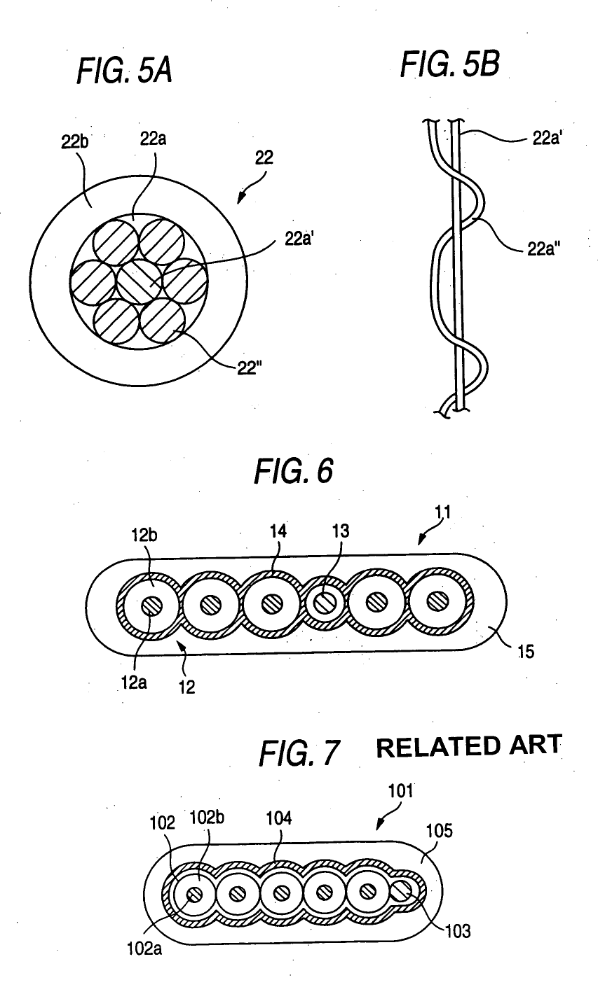

In the second embodiment, as shown in FIGS. 5A and 5B, the central wire element 22a′ made of copper is disposed straight, and the peripheral wire elements 22a″ made of a copper alloy are twisted around the central wire element 22a′ therealong. The peripheral wire elements 22a″ has a certain amount of margin in length direction whereas the central wire element 22a′, disposed straight, has less amount of margin in length direction than the peripheral wire elements 0.22a″. Therefore, when the shielded flat cable is pulled in length direction, the central wire element 22a′ is most liable to be cut and becomes disconnected first, and therefore copper which is most liable to be extended is used to form the central wire element 22a′. The peripheral wire elements 22a″ (which are made of the copper alloy having a high tensile strength and a high strength) are arranged around the central wire element 22a′ to provide the twisted-wire structure, and by doing so, the well-balanced structure is provided.

The conductor 22a of the signal wire 22 has an overall tensile strength preferably of about 1,500 N/mm² to about 1,600 N/mm² and an elongation preferably of about 5%.

From a viewpoint of a thin and lightweight design, the conductor size of the conductor 22a is preferably about 0.05 mm² to about 0.13 mm².

The diameter of the central wire element 22a′ is determined in accordance with the outer diameter of the signal wire 22, and usually the diameter is about 0.122 mm to about 0.132 mm. In the case where 6 twisted wire elements (except the central wire element) are used, the diameter of each peripheral wire element 22a″ is about 0.122 mm to about 0.132 mm.

The outer diameter of the signal wire 22 is suitably determined according to a use, and normally set to about 0.37 mm to about 0.40 mm.

The number of the juxtaposed signal wires 22 may be arbitrarily determined according to a use.

Other elements of the cable than the conductor 22a of the signal wires 22 (that is, the insulating coating layer 22b, the drain wire 23, the shielding layer 24 and the insulating sheath 25) are similar to those of the first embodiment, respectively, and therefore explanation thereof will be omitted.

Hereinafter, a description will be made of a comparison between examples of shielded flat cables of the second embodiment and an example of a conventional shielded flat cable.

A third product (product 3) according to the first embodiment is made with the following characteristics.
shielded flat cable 21;
   width: 3.94 mm, thickness: 1.98 mm
two signal wires 22;
   material for conductor 22a: Cu and Cu—Ag, conductor size: 0.08 mm², 7-wire stranded type (including central wire element 22a′), conductor size of central wire element 22a′: 0.013 mm², conductor size of each peripheral wire element 22a″: 0.013 mm², material for insulating coating layer 22b: foamed polyethylene, outer diameter of each signal wire: 1.35 mm
drain wire 23;
   material: Sn-plated copper, conductor size: 0.22 mm²
shielding layer 24;
   material: copper foil, thickness: 15 μm
insulating sheath 25;
   material: halogen-free material, thickness: 0.3 mm.

A fourth product (product 4) according to the second embodiment is made with the following characteristics.
shielded flat cable 21;
   width: 3.94 mm, thickness: 1.98 mm
two signal wires 22;
   material for conductor 22a: Cu and Cu—Ni—Si, conductor size: 0.08 mm², 7-wire stranded type (including central wire element 22a′), conductor size of central wire element 22a′: 0.013 mm², conductor size of each peripheral wire element 22a″: 0.013 mm², material for insulating coating layer 22b: foamed polyethylene, outer diameter of each
signal wire: 1.35 mm drain wire 23;
   material: Sn-plated copper, conductor size: 0.22 mm²
shielding layer 24;
   material: copper foil, thickness: 15 μm
insulating sheath 25;
   material: halogen-free material, thickness: 0.3 mm.

A conventional product according to a conventional shielded flat cable is made the same as used in the first embodiment.

The breaking strength of each of the above shielded flat cables was measured. Measurement results are shown in the following.
Product 3 according to the second embodiment: 111 N
Product 4 according to the second embodiment: 69 N
Conventional Product: 53 N.

As apparent from the above result that in the shielded flat cable of the second embodiment of the invention, even when the conductor size of the conductors of the signal wires are reduced, the buckling and disconnecting of the conductors can be effectively prevented and that the thin and lightweight design of the shielded flat cable can be achieved. It has also been confirmed that even when the cable is forcibly bent in the direction of the width thereof during the installation of the cable, the strength, withstanding the cutting of the conductor, is enhanced.

Although the second embodiment of the invention has been described above, the present invention is not limited to the above configuration, and various modifications and changes can be made.

For example, the second embodiment can be applied to a shielded flat cable having the structure shown in FIG. 3.

Hereinafter, a third embodiment of the invention will be described referring to FIG. 6. In the first embodiment, the drain wire 13 is disposed on one side of the group of the signal wires 12 whereas in the third embodiment, as shown in FIG. 6, the drain wire 13 is disposed in between the signal wires 12. The configuration of the shielded flat cable 11 of the third embodiment only differs with that of the first embodiment shown in FIG. 1 in position of the drain wire 13. Therefore, an explanation of the members other than the drain wire 13 will be omitted in the following description.

In the third embodiment, the drain wire 13 is disposed in between the signal wires 12, and the outermost two signal wires 12, which disposed on both sides of the group of the signal wires 12 is made of a copper alloy. Hereby, sufficient strength has been acquired in the shielded flat cable 11 of the third embodiment. In addition, when the shielded flat cable 11 is bent in a direction of the width thereof, the occurrence of the buckling or breaking (disconnection) is efficiently prevented.

It is also preferable to combine the configuration of the second and the third embodiment, to thereby incorporate the twisted-wire structure of the second embodiment into the outermost two signal wires 12 of the third embodiment.

In the present invention, the above construction is adopted, and therefore there can be provided the shielded flat cable in which even when the conductor size of the conductors of the signal wires are reduced as much as possible so as to achieve the thin and lightweight design, the buckling and disconnecting of the conductors of the signal wires can be effectively prevented, and the transmission characteristics are more enhanced.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

1. A shielded flat cable comprising:
a plurality of signal wires each having a conductor coated with insulating layer, wherein a substantive total cross-sectional area of the conductor of each of the signal wires is in range of from 0.03 mm² to 0.13 mm² respectively;
a drain wire;
a shielding layer covering an outer periphery of the signal wires and the drain wire; and
an insulating sheath covering an outer periphery of the shielding layer,
wherein the signal wires and the drain wire are juxtaposed to one another in closely-contacted relation to one another, and
wherein the conductor of at least the outermost signal wire is made of a copper alloy.

2. The shielded flat cable as claimed in claim 1, wherein the drain wire is provided at one of ends of the plurality of signal wires.

3. The shielded flat cable as claimed in claim 1, wherein a substantive total cross-sectional area of the conductor of each of the signal wires is in range of from 0.05 mm² to 0.13 mm², respectively.

4. The shielded flat cable as claimed in claim 3, wherein the substantive total cross-sectional area of the conductor of each of the signal wires is in range of from 0.03 mm² to 0.08 mm², respectively.

5. The shielded flat cable as claimed in claim 1, wherein the conductor of at least the outermost signal wire is made of a Cu—Ag alloy.

6. The shielded flat cable as claimed in claim 5, wherein the Cu—Ag alloy includes 2.5% by weight to 5.5% by weight of Ag.

7. The shielded flat cable as claimed in claim 1, wherein the conductor of at least the outermost signal wire is made of a Cu—Ni—Si alloy.

8. The shielded flat cable as claimed in claim 7, wherein the Cu—Ni—Si alloy includes 2.0% by weight to 3.0% by weight of Ni and 0.4% by weight to 0.8% by weight of Si.

9. The shielded flat cable as claimed in claim 1, wherein the conductor of each of the signal wires is made of a stranded wire, respectively.

10. The shielded flat cable as claimed in claim 1, wherein the conductor of each of the signal wires is made of a single wire, respectively.

11. The shielded flat cable as claimed in claim 1, wherein the conductor of at least the outermost signal wire is made of a copper alloy having a tensile strength in a range of from 500 N/mm² to 1,400 N/mm².

12. The shielded flat cable as claimed in claim 1, wherein the conductor of at least the outermost signal wire is made of a copper alloy having an elongation in a range of from 5% to 15%, and
wherein a diameter of the conductor of at least the outermost signal wire is configured to be in a range of from 0.1 mm to 0.25 mm.

13. A shielded flat cable comprising:
a plurality of signal wires each having a conductor coated with insulating layer;
a drain wire;
a shielding layer covering an outer periphery of the group of the signal wires and the drain wire; and
an insulating sheath covering an outer periphery of the shielding layer,
wherein the signal wires and the drain wire are juxtaposed to one another in closely-contacted relation to one another,
wherein the conductor of at least the outermost signal wire comprises: a linear central wire element disposed at a longitudinal axis of the conductor; and a peripheral wire element stranded around the central wire element therealong,
wherein the central wire element is made of copper, and
wherein the peripheral wire element is made of copper alloy.

14. The shielded flat cable as claimed in claim 13, wherein the drain wire is provided at one of ends of the plurality of signal wires.

15. The shielded flat cable as claimed in claim 13, wherein a substantive total cross-sectional area of the conductor of each of the signal wires is in range of from 0.05 mm² to 0.13 mm², respectively.

16. The shielded flat cable as claimed in claim 15, wherein the substantive total cross-sectional area of the conductor of each of the signal wires is in range of from 0.03 mm² to 0.08 mm², respectively.

17. The shielded flat cable as claimed in claim 13, wherein the peripheral wire element comprises a plurality of peripheral wire elements.

18. The shielded flat cable according to claim 13, wherein the peripheral wire element is made of a Cu—Ag alloy.

19. The shielded flat cable as claimed in claim 18, wherein the Cu—Ag alloy includes 2.5% by weight to 5.5% by weight of Ag.

20. The shielded flat cable according to claim 13, wherein the peripheral wire element is made of a Cu—Ni—Si alloy.

21. The shielded flat cable as claimed in claim 20, wherein the Cu—Ni—Si alloy includes 2.0% by weight to 3.0% by weight of Ni and 0.4% by weight to 0.8% by weight of Si.

22. The shielded flat cable as claimed in claim 13, wherein the conductor of at least the outermost signal wire is made of a copper alloy having a tensile strength in a range of from 500 N/mm² to 1,400 N/mm².

23. The shielded flat cable as claimed in claim 13, wherein the conductor of at least the outermost signal wire is made of a copper alloy having an elongation in a range of from 5% to 15%, and
wherein a diameter of the conductor is configured to be in a range of from 0.1 mm to 0.25 mm.

24. A shielded flat cable comprising:
a plurality of signal wires each having a conductor coated with an insulating layer;
a drain wire;
a shielding layer covering an outer periphery of the group of the signal wires and the drain wire; and
an insulating sheath entirely covering an outer periphery of the shielding layer,
wherein the signal wires and the drain wire are juxtaposed to one another in closely-contacted relation to one another, and
wherein the conductor of at least the outermost signal wire is made of a copper alloy.

25. The shielded flat cable as claimed in claim 24, wherein the plurality of signal wires are juxtaposed to form a group of juxtaposed signal wires with a first juxtaposed signal wire and a last juxtaposed signal wire;
wherein the drain wire is juxtaposed to the last juxtaposed signal wire; and
wherein at least the first juxtaposed signal wire in the group is made of copper alloy.

26. The shielded flat cable as claimed in claim 13, wherein the plurality of signal wires are juxtaposed to form a group of juxtaposed signal wires with a first juxtaposed signal wire and a last juxtaposed signal wire;
wherein the drain wire is juxtaposed to the last juxtaposed signal wire;
wherein at least the first juxtaposed signal wire in the group includes a linear central wire element disposed at a longitudinal axis of the conductor and a peripheral wire element stranded around the central wire element therealong.

27. The shielded flat cable as claimed in claim 1, wherein the plurality of signal wires are juxtaposed to form a group of juxtaposed signal wires with a first juxtaposed signal wire and a last juxtaposed signal wire;
wherein the drain wire is juxtaposed to the last juxtaposed signal wire; and
wherein at least the first juxtaposed signal wire in the group is made of copper alloy.

28. A shielded flat cable comprising:
a plurality of signal wires each having a conductor coated with insulating layer, wherein a substantive total cross-sectional area of the conductor of each of the signal wires is in range of from 0.03 mm to 0.13 mm², respectively;
a drain wire;
a shielding layer covering an outer periphery of the group of the signal wires and the drain wire; and
an insulating sheath covering an outer periphery of the shielding layer;
wherein the plurality of signal wires are juxtaposed in closely-contacted relation to one another to form a group of juxtaposed signal wires with a first juxtaposed signal wire and a last juxtaposed signal wire;
wherein the drain wire is juxtaposed in closely-contacted relation to the last juxtaposed signal wire; and
wherein at least the first juxtaposed signal wire in the group is made of copper alloy.

29. A shielded flat cable comprising:
a plurality of signal wires each having a conductor coated with insulating layer;
a drain wire;
a shielding layer covering an outer periphery of the group of the signal wires and the drain wire; and
an insulating sheath covering an outer periphery of the shielding layer,
wherein the plurality of signal wires are juxtaposed in closely-contacted relation to one another to form a group of juxtaposed signal wires with a first juxtaposed signal wire and a last juxtaposed signal wire;
wherein the drain wire is juxtaposed in closely-contacted relation to the last juxtaposed signal wire;
wherein at least the first juxtaposed signal wire in the group includes a linear central wire element disposed at a longitudinal axis of the conductor and a peripheral wire element stranded around the central wire element therealong,
wherein the central wire element is made of copper, and
wherein the peripheral wire element is made of copper alloy.
